(19) United States
(12) Patent Application Publication
(10) Pub. No.: US 2020/0305603 A1
(43) Pub. Date: Oct. 1, 2020

(54) WATERCOLOR PAINTING FRAME DEVICE

(71) Applicant: Eric M. Davis, La Verne, CA (US)

(72) Inventor: Eric M. Davis, La Verne, CA (US)

(21) Appl. No.: 16/438,941

(22) Filed: Jun. 12, 2019

Related U.S. Application Data
(60) Provisional application No. 62/825,527, filed on Mar. 28, 2019.

(51) Int. Cl. A47B 97/04; F16M 11/24; B44D 3/02; B44D 3/12; B44D 3/04; B44D 3/18; B43L 5/02

(52) U.S. Cl. CPC A47B 97/04; F16M 11/242; B44D 3/02; B43L 5/02; B44D 3/04; B44D 3/18; B44D 3/123

(57) ABSTRACT

A painting frame for forming a border on a painting having an opening defining an image area of the painting, a lower frame hingedly attached to the upper frame forming a support structure for the painting, a gasket attached to a perimeter of the opening in the upper frame for forming a seal for the image area of the painting and clamps for attaching the upper frame and the lower frame to create a liquid proof seal for the gasket.

### CROSS-REFERENCE TO RELATED APPLICATION(S)

This application claims priority to and the benefit of U.S. Provisional Application No. 62/825,527 filed Mar. 28, 2019, the contents of which are incorporated herein.

### BACKGROUND OF THE INVENTION

The present invention is directed to a watercolor frame device used for watercolor painting having the dual purpose of stretching watercolor paper and providing a border which restricts any fluid for pigment from entering the border of the watercolor paper eliminating the need to mask or tape the paper's edge.

Before being painted upon, watercolor paper must be made taut and flat. It must be maintained taut during the painting process so that watercolor or other media when applied to it does not act to buckle or wrinkle the paper causing difficulty during painting. Common methods used for preparing and maintaining watercolor paper taut and flat for painting involve soaking watercolor paper until the fibers are saturated, then placing the wet paper onto a board of length and width larger than those of the paper and securing the paper to the board by means of adhesion or mechanical fasteners, allowing the paper to dry or painting upon it while damp by applying water, paint or other aqueous media onto the paper. Typical adhesion of the paper to the board is by gummed tape, or mechanical fasteners including staples or pressure clamps tightened with screws or bolts to firmly attach the paper to the board. Masking tape used to create a border on the watercolor paper is time consuming and can potentially damage the watercolor paper after the painting is complete and the tape is removed. Consequently, a need exists for an improved device used during watercolor painting to easily create a border and eliminate the need for masking tape or mechanical fasteners driven through the paper into a board.

Another method of watercolor painting included the use of a watercolor paper block which comprises a plurality of watercolor paper sheets stacked upon one another. A problem with using a watercolor block is that the integrity of the block had a tendency to fail early in its use resulting in damaged lower layers or complete failure resulting in significant waste or watercolor paper. Consequently, a need exists for a device allowing for watercolor painting utilizing a single sheet of watercolor paper at a time.

### SUMMARY OF THE INVENTION

The present invention is directed to a watercolor painting frame device which addresses the drawbacks of prior methods which eliminates the need to mask the paper, or the use of mechanical fasteners and provides for watercolor painting by using a single sheet of watercolor paper at a time. The present invention is a frame having a seal for watercolor painting to prevent paint from reaching the edges of the watercolor paper thereby creating a border. The frame is a hinged, sandwich style, one side opening frame configured to hold a single sheet of paper. A rubber, or synthetic rubber, gasket is provided along a peripheral portion of the upper frame section such that when the frame is clamped together, the gasket creates a seal protecting the outer border of the watercolor paper from receiving any pigment or water. The frame includes a mounting structure so that it can be attached on a tri-pod, easel or other support structure. The upper and lower frame sections are clamped together with C-shaped clamps. The C-shaped clamps can be modified to include holders for painting accessories such as trays, water containers, brushes or a paint palette. A threaded tri-pod connection is positioned on the back surface of the lower section of the frame for connection to a tri-pod.

Alternatively, rails can be attached through the backside of the lower section for attaching to an easel or other support structure. Registration markings are positioned around the perimeter of the upper portion of the frame device for aligning the watercolor paper in the device and providing for reference locations during painting.

The gasket around the upper portion of the frame is designed to not only provide a seal protecting the outer border of the sheet from receiving any pigment or water but is angled such that any excess pigment or water does not pool along the lower edge of the frame device and acts to channel the liquid off of the frame when the frame is in a tilted configuration on a tri-pod or other supporting structure. These and other advantages and features of the present invention will be more readily understood by reference to the detailed description and drawings hereinafter.

### BRIEF DESCRIPTION OF THE DRAWINGS

FIG. 1 is a perspective view of the watercolor painting frame device of the present invention in a closed position;

FIG. 2 is a perspective view of the device of FIG. 1 in an open position;

FIG. 3 is a perspective view of FIG. 1 including accessories;

FIG. 4 is a bottom view of the device of FIG. 1; and

FIGS. 5a-5d are detail views of the gasket of the device of FIG. 1.

### DETAILED DESCRIPTION

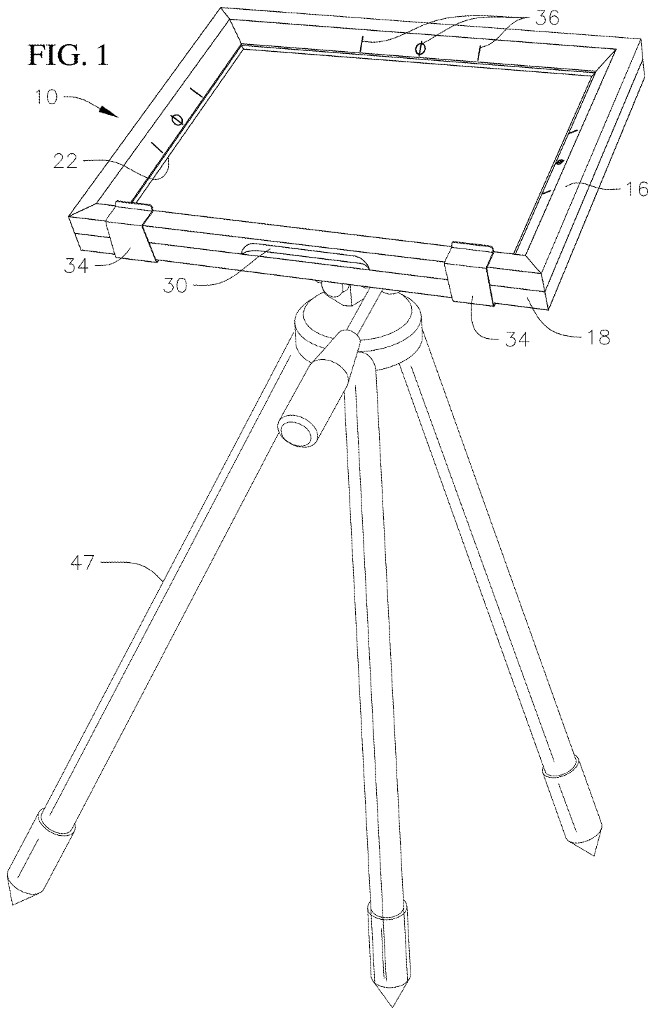

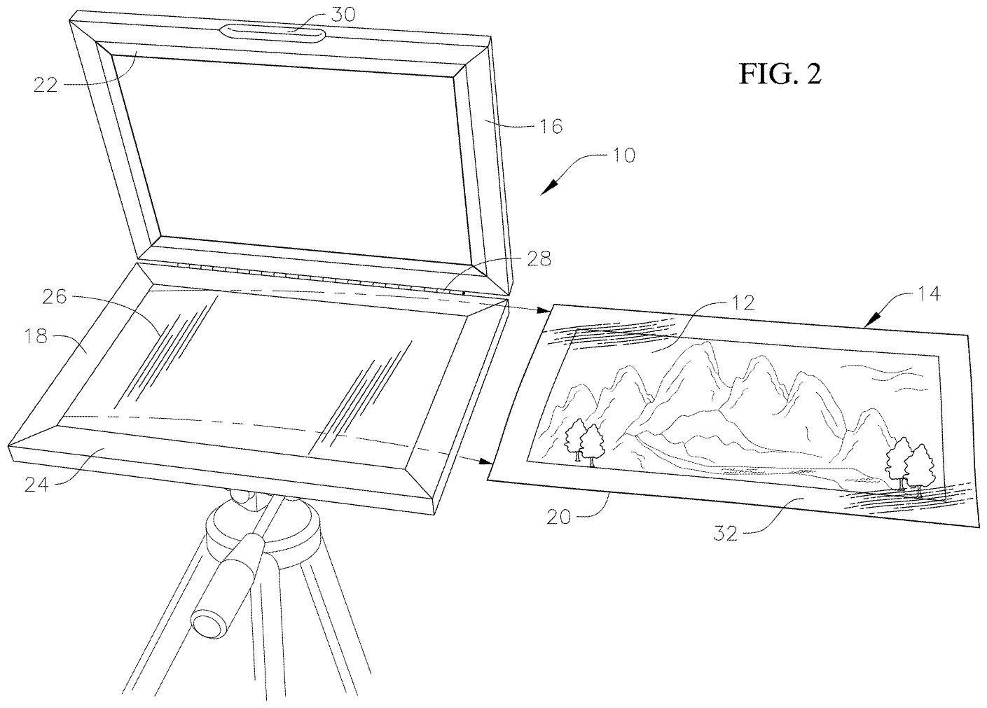

As shown in FIGS. 1 and 2, the present invention is directed to a watercolor painting frame device 10 used in watercolor painting that automatically masks off the painting image area 12 of a watercolor painting 14. The frame device 10 consists of an upper portion 16 and a lower portion 18 in which watercolor paper 20 is positioned between. The upper portion 16 of the device has a solid perimeter and an opening which together with a gasket 22 form the boundaries of the image area 12 to be painted. The lower portion 18 is a solid board upon which the watercolor paper 20 is positioned and provides a support surface for the paper during painting. The lower portion 18 has a peripheral boundary portion 24, the same dimensions as the upper portion 16 and a center section 26 which has the same dimension as the image area 12 of the watercolor painting 14. The center section 26 typically can have a dry erase board surface mounted on Masonite. The peripheral boundary portion 24 and the upper portion 16 can be made of wood, such as maple, however other materials can be utilized for these components such as metal, plastic, or other rigid materials.

The upper portion 16 and the lower portion 18 of the device are hingedly connected by a piano hinge 28 positioned along one edge of the device. A recess 30 is positioned along an opposite edge front face of the upper portion 16 for insertion of a user's fingers to lift and pivot the upper portion from the lower portion to insert and remove watercolor paper. As indicated, the gasket 22 is positioned along the perimeter of the inside opening of the upper portion 16 such that when the upper portion and lower portion of the device are closed creates a seal protecting the outer border 32 of the watercolor paper from receiving any undesirable pigment, water or other liquids. The gasket 22 forms a seal by clamping the upper portion and the lower portion together with clamps 34 spaced along the lower edge of the device opposite from the hinged connection. Clamps 34 are C-shaped brackets typically made of stainless steel sized to engage the device with a compression fit sufficient to form a liquid seal between the gasket and the watercolor paper.

In this configuration, the device 10 is a hinged, sandwiched style, frame configured to hold a single sheet of watercolor paper including a rubber gasket along a peripheral portion such that when the frame is clamped together by the clamps, the gasket creates a seal protecting the outer border of the watercolor paper from receiving undesirable liquid.

The upper portion 16 of the device includes markings 36 positioned around the perimeter of the image area 12 to provide indicia for either alignment of the watercolor paper during insertion or removal or can serve as references for dividing the image area into segments both longitudinally and laterally, for example, in half or in thirds when painting.

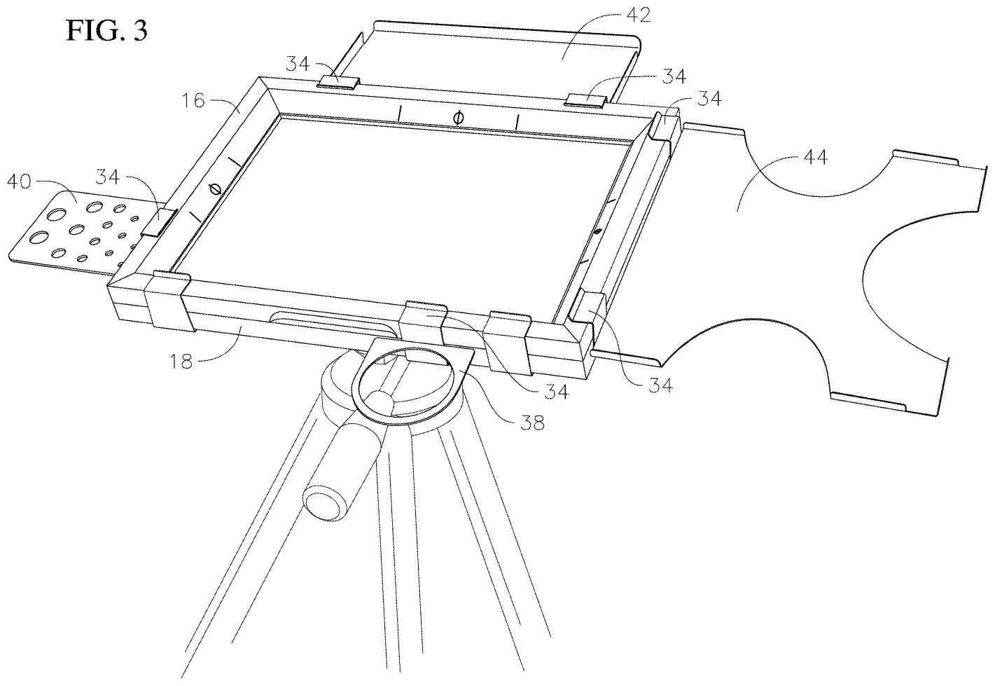

As illustrated in FIG. 3, the device also includes accessories which can be attached to the upper portion of the frame 16 and the lower portion of the frame 18 including a water cup or jar holder 38, a paintbrush holder 40, a paint tray 42, and a pallete holder 44. These accessories are typically made of stainless steel and are welded onto a clamp similar to clamp 34 and then positioned around the perimeter of the device. The cup/jar holder is a ring having an opening for receipt of the cup/jar. The brush holder has a series of different size holes through a plate in which different size brushes would be positioned.

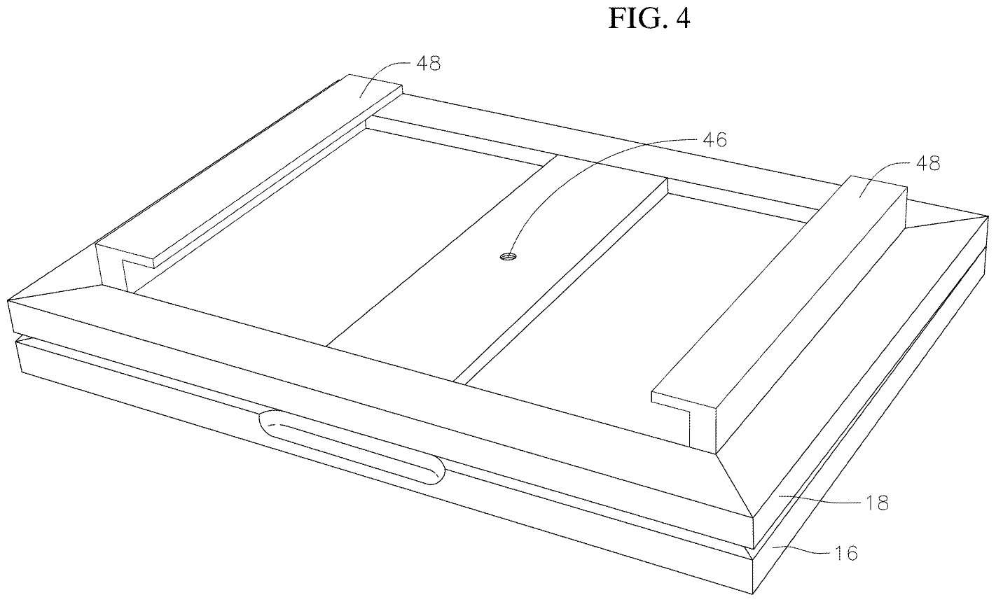

The device 10 includes a tri-pod connection 46 which is a threaded hole position on the bottom surface of the lower portion 18 as shown in FIG. 4. Attaching the device 10 to a tri-pod 47 allows for the height of the device to be raised and lowered or tilted at any desired angle by the user. Other attachment mechanisms can also include rails 48 positioned on the lower surface of the lower portion of the frame for attachment to other support mechanisms, such as an easel. For example, an easel such as disclosed in Applicant's U.S. Design Patent No. D736,012 would be ideal for use in connection with the device of the present invention, the contents of which are incorporated herein by reference.

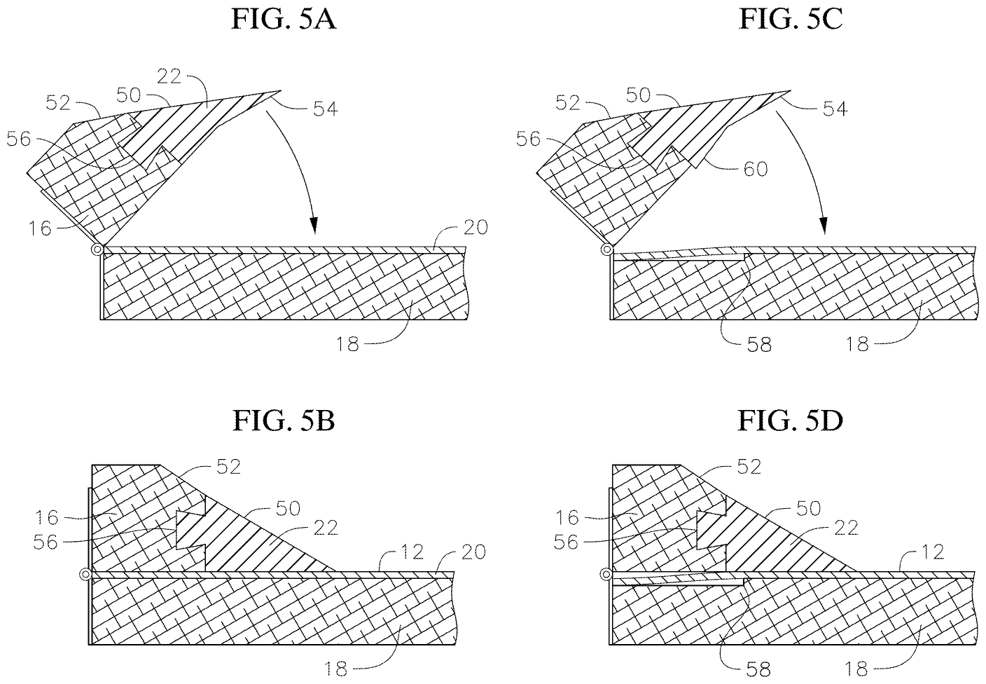

Referring to FIGS. 5A-5D, the gasket 22 of the present invention has been designed to prevent watercolor pigment, water or any other liquid from pooling along the lower surface of the image area 12 while painting with the device in an angled orientation by providing a beveled surface 50 extending from the edge of the image area 12 of the watercolor paper 20 to a beveled edge 52 of the upper portion 16 of the device. The smooth transition between the image area onto the gasket and the beveled surface 52 of the upper portion 16 prevents pooling by allowing excess liquid to run off the device. As illustrated in FIG. 5A, the lower surface of the gasket 22 also includes an angled portion 54 such that when it is compressed upon the paper as shown in FIG. 5B, it ensures a liquid type seal against the paper. The backside of the gasket includes a dovetail section 56 for engaging the upper portion 16 of the device. In the embodiment shown in FIGS. 5A and 5B the lower portion 18 of the frame forms a flat surface for receipt of the watercolor paper 20. In the embodiment shown in FIGS. 5C and 5D the lower portion 18 includes a stepped surface 58 and in this embodiment the gasket 22 includes two angled portions 54 and 60 along a lower surface to ensure a water tight seal upon compression with the step surface 58.

Besides providing a masked off border 32 for the watercolor painting, the device of the present invention also serves to stretch the watercolor paper when wetted by firmly holding the watercolor paper in the device through the clamping action of the upper and lower portions, gasket and clamps.

Although the present invention has been described and illustrated with respect to specific embodiments thereof, it is to be understood that changes and modifications can be made therein which are within the full intended scope of the invention as hereinafter claimed.

What is claimed is:

1. A painting frame device for forming a border for a painting comprising:
an upper frame portion having an opening defining an image area of the painting;
a lower frame portion hingedly attached to the upper frame portion forming a support surface for a painting;
a gasket attached to a perimeter of the opening in the upper frame portion for forming a seal against the image area of the painting; and
at least one clamp for attachment to the upper frame portion and the lower frame portion to create a liquid proof seal for the gasket.

2. The device of claim 1 wherein the lower frame portion has a dry-erase surface for the image area of the painting.

3. The device of claim 1 further comprising a piano hinge positioned between the upper frame portion and the lower frame portion.

4. The device of claim 1 wherein the upper frame portion has a recess for pivoting the upper frame portion.

5. The device of claim 1 wherein there are two clamps spaced from one another.

6. The device of claim 1 wherein the upper frame portion includes perimeter markings creating aligning and painting indicia.

7. The device of claim 1 wherein the device further includes one or more accessories including a jar holder, brush holder, paint tray or palette holder positioned around a perimeter of the device.

8. The device of claim 7 wherein the accessories are attached to a clamp.

9. The device of claim 1 wherein the lower frame portion includes a tri-pod connection.

10. The device of claim 1 wherein the lower frame portion includes rails for attachment to a support structure.

11. The device of claim 1 wherein the gasket has a beveled edge to prevent liquid pooling on the painting.

12. The device of claim 11 wherein the beveled edge of the gasket is positioned on an upper surface of the gasket and a lower surface of the gasket.

13. A watercolor painting frame device having a top portion and a bottom portion for receipt of a sheet of watercolor paper there between, the frame having a gasket on the top portion and a clamp for forming a watertight seal for the gasket against the watercolor paper.

14. The device of claim 13 further comprising a hinge for connecting the top portion to the bottom portion.

15. The device of claim 13 wherein the top portion includes perimeter markings creating aligning and painting indicia.

16. The device of claim 13 further including one or more accessories comprising a jar holder, brush holder, paint tray or palette holder positioned around a perimeter of the device.

17. The device of claim 13 wherein the bottom portion includes a tri-pod connection.

18. The device of claim 13 wherein the bottom portion includes rails for attachment to a support structure.

19. The device of claim 13 wherein the gasket has a beveled edge to prevent pooling on the watercolor paper.

20. The device of claim 19 wherein the beveled edge of the gasket is positioned on an upper surface of the gasket and a lower surface of the gasket.
